(19) United States
(12) Patent Application Publication
(10) Pub. No.: US 2025/0131726 A1
(43) Pub. Date: Apr. 24, 2025

(54) VEHICLE IDENTIFICATION SYSTEM

(71) Applicant: TOYOTA JIDOSHA KABUSHIKI KAISHA, Toyota-shi (JP)

(72) Inventors: Tatsuya Sugano, Sunto-gun (JP); Koji Morita, Gotemba-shi (JP); Hiroya Chiba, Fuji-shi (JP)

(73) Assignee: TOYOTA JIDOSHA KABUSHIKI KAISHA, Toyota-shi (JP)

(21) Appl. No.: 18/808,585

(22) Filed: Aug. 19, 2024

(30) Foreign Application Priority Data
Oct. 19, 2023 (JP) 2023-180300

(51) Int. Cl. G06V 20/52; B60Q 1/48; G06V 10/60; H04N 23/60

(52) U.S. Cl. CPC G06V 20/52; B60Q 1/482; G06V 10/60; H04N 23/60; G06V 2201/07; G06V 2201/08

(57) ABSTRACT

A vehicle identification system identifies a target vehicle. First, the vehicle identification system instructs a first vehicle to start performing a predetermined action for identifying the target vehicle while the first vehicle is traveling in a vehicle identification zone. Next, the vehicle identification system starts a recognition process of recognizing an action performed by the first vehicle using a sensor while the first vehicle is travelling in the vehicle identification zone. Then, the vehicle identification system identifies the first vehicle that performs the predetermined action as the target vehicle.

### CROSS-REFERENCE TO RELATED APPLICATION

The present disclosure claims priority to Japanese Patent Application No. 2023-180300, filed on Oct. 19, 2023, the contents of which application are incorporated herein by reference in their entirety.

### TECHNICAL FIELD

The present disclosure relates to a technique for identifying a target vehicle.

### BACKGROUND ART

Identifying a target vehicle is important in functions of providing control and services to the target vehicle. For example, in automated valet parking (AVP) in a parking lot, it is required to identify a target vehicle of AVP from the viewpoint of reliability and safety.

Patent Literature 1 discloses a vehicle authentication method in a parking lot as a technique related to identification of a target vehicle. The vehicle authentication method disclosed in Patent Literature 1 transmits information instructing a target vehicle to perform a predetermined action, confirms whether a vehicle in a parking lot has performed the predetermined action, and performs localization by authenticating the vehicle that has performed the predetermined action as the target vehicle.

In addition, the following Patent Literatures 2 and 3 are documents showing the technical level of the present technical field.

### LIST OF RELATED ART

Patent Literature 1: U.S. Pat. No. 10,532,771 B2
Patent Literature 2: JP 2021099601 A
Patent Literature 3: JP 2018112981 A

### SUMMARY

Patent Literature 1 discloses a technique for performing vehicle identification (authentication) based on an action performed by a vehicle. In particular, in Patent Literature 1, the vehicle identification is performed in a state where the vehicle is stopped at a drop-off position. When vehicle identification is performed based on an action performed by a vehicle, the vehicle identification takes a certain amount of time since the vehicle is required to perform the action having a certain duration. Therefore, in the technique disclosed in Patent Literature 1, the vehicle continues to stop at the drop-off position for a while from the start to the completion of the vehicle identification. It is not preferable that a vehicle occupies a space for a long time because it hinders efficient traffic.

An object of the present disclosure is, in view of the above problems, to suppress the occurrence of a situation in which efficient traffic is hindered with respect to a technique for identifying a target vehicle.

One aspect of the present disclosure is directed to a vehicle identification system for identifying a target vehicle.

The vehicle identification system comprises one or more processors.

The one or more processors are configured to:
instruct a first vehicle to start performing a predetermined action for identifying the target vehicle while the first vehicle is traveling in a vehicle identification zone;
start a recognition process of recognizing an action performed by the first vehicle using a sensor while the first vehicle is travelling in the vehicle identification zone; and
identify the first vehicle that performs the predetermined action as the target vehicle.

According to the present disclosure, the instruction to start performing the predetermined action is given while the first vehicle is traveling in the vehicle identification zone, and the recognition process is started. This can achieve, when the first vehicle stops to receive the provision of the function, a state where the identification of the target vehicle has been completed or where a part of the action performed by the first vehicle has been recognized. Therefore, the time during which the target vehicle is stopped can be shortened in the vehicle identification. In addition, it is possible to suppress the occurrence of a situation in which efficient traffic is hindered.

### BRIEF DESCRIPTION OF DRAWINGS

FIG. 1 is a conceptual diagram for explaining automated valet parking in a parking lot;

FIG. 2 is a conceptual diagram for explaining an outline of a vehicle identification system according to the present embodiment;

FIG. 3 is a conceptual diagram showing an example of a problem related to selection of a camera used in a recognition process;

FIG. 4 is a conceptual diagram for explaining an outline of a camera selection process;

FIG. 5 is a flowchart showing an example of a process executed in the vehicle identification system; and

FIG. 6 is a diagram showing an example of a hardware configuration of the vehicle identification system according to the present embodiment.

### DETAILED DESCRIPTION

### 1. Introduction

Various functions for providing control and services to a target vehicle have been considered. One such function is automated valet parking (AVP) at a parking lot. The AVP automatically performs the loading and unloading of the target vehicle in the parking lot without the user's operation. In addition, the function of carrying in, carrying out, and arranging the target vehicle in the garage by the transporting device is exemplified.

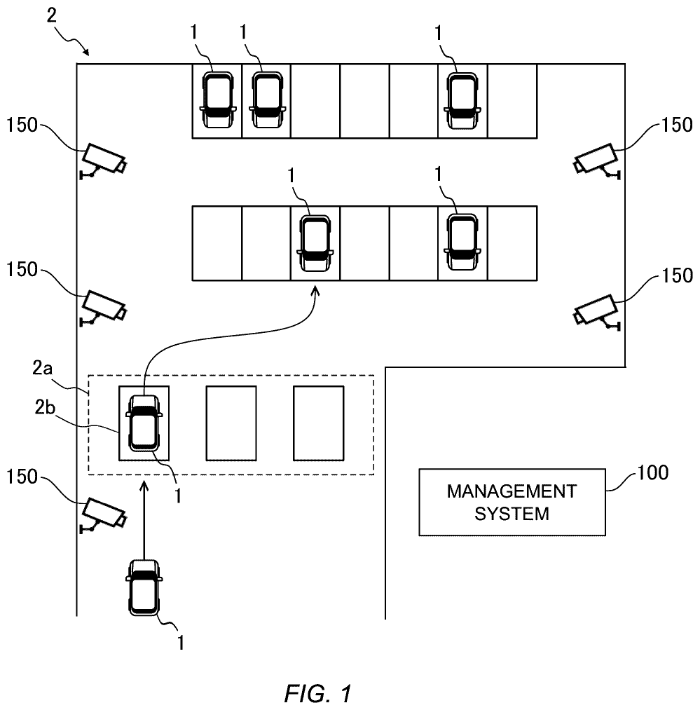

FIG. 1 is a conceptual diagram for explaining an AVP. The management system 100 manages the AVP in the parking lot 2. A sensor 150 that detects the position and state of each vehicle 1 in the parking lot 2 is installed in the parking lot 2. The management system 100 manages information of the parking lot 2 and each vehicle 1 based on detection information acquired using the sensor 150. Then, the management system 100 communicates with the target vehicle in the parking lot 2 (for example, by wireless LAN) and performs the AVP of the target vehicle. For example, a case where the user intends to park the vehicle 1 by the AVP will be considered. The user stops the vehicle 1 (target vehicle) to be entered at the vehicle stop position 2b of the entry area 2a. The user requests the AVP after getting off the vehicle 1 (target vehicle) at the vehicle stop position 2b. The management system 100 transmits command information such as a parking position and a traveling route to the target vehicle based on the management data related to the parking lot 2 and each vehicle 1. The AVP related to the vehicle entry is performed by controlling the target vehicle according to the command information received by the control system of the target vehicle.

In the AVP, it is required to identify a target vehicle at the time of entering the parking lot from the viewpoint of reliability and safety (identification can also be referred to as authentication). This is to confirm that the vehicle 1 stopping at the vehicle stop position 2b is the vehicle 1 (target vehicle) of the authorized user. When the vehicle identification is successful, the vehicle 1 stopping at the vehicle stop position 2b is determined to be a legitimate target vehicle, and the AVP is started. By identifying the target vehicle in this way, only the authorized target vehicle can be permitted to enter the parking lot. On the contrary, if the target vehicle is not identified, an irrelevant vehicle which is not the target vehicle may enter the garage. This is a problem from the viewpoint of reliability and safety. Similarly, in a function of providing control and service to other target vehicles (hereinafter, referred to as “function of AVP or the like”), it is generally required to identify the target vehicle.

The vehicle identification system according to the present embodiment can be configured to identify a target vehicle in the function of AVP or the like. The vehicle identification system according to the present embodiment employs a method of instructing the vehicle 1 to execute an action and identifying a target vehicle based on whether or not the action recognized using the sensor 150 matches an expected action (hereinafter, referred to as an “action-based identification method”).

Here, the action can be defined by a combination of a device for executing the action and an operation pattern of the device. Examples of the device that performs the action include a lighting device (a headlight, a brake light, a fog light, or the like), an in-vehicle illumination device, a horn, a direction indicator, a wiper, a door, a door window, an engine, and an electric motor. For example, one action is to flash the lights of the headlights in a specified pattern. For example, one of the actions is to sound the horn in a specified pattern. The action may include a request for a repetition of the motion pattern.

In the action-based identification method, it is necessary to detect an action of the vehicle 1 using the sensor 150. Therefore, the sensor 150 is configured to be able to detect at least an action to be executed by the vehicle 1. For example, when a visible action (an action related to the lighting of the lighting device, or the like) that can be visually detected is executed, the sensor 150 is configured by a camera. Further, for example, in a case where an audible action (an action related to sounding of a horn, or the like) that can be detected aurally is executed, the sensor 150 is configured by a microphone.

The action-based identification method has advantages such as high flexibility, which can provide a degree of freedom in designing an action used for vehicle identification. On the other hand, in the action-based identification method, the vehicle 1 is required to execute an action having a certain duration, and thus a certain amount of time is required for vehicle identification. Therefore, in the related art (for example, the technique disclosed in Patent Literature 1), it is assumed that the vehicle 1 continues to stop at the vehicle stop position 2b for a while from the start to the completion of the vehicle identification. However, it is not preferable that the vehicle 1 occupies a certain space for a long time because efficient traffic is hindered. For example, in the AVP, efficient vehicle loading of the vehicle 1 is hindered, and there is a concern that congestion of vehicles 1 waiting for loading may be caused.

In view of the above problem, the vehicle identification system according to the present embodiment enables identification of a target vehicle while suppressing occurrence of a situation in which efficient traffic is hindered.

### 2. Vehicle Identification System

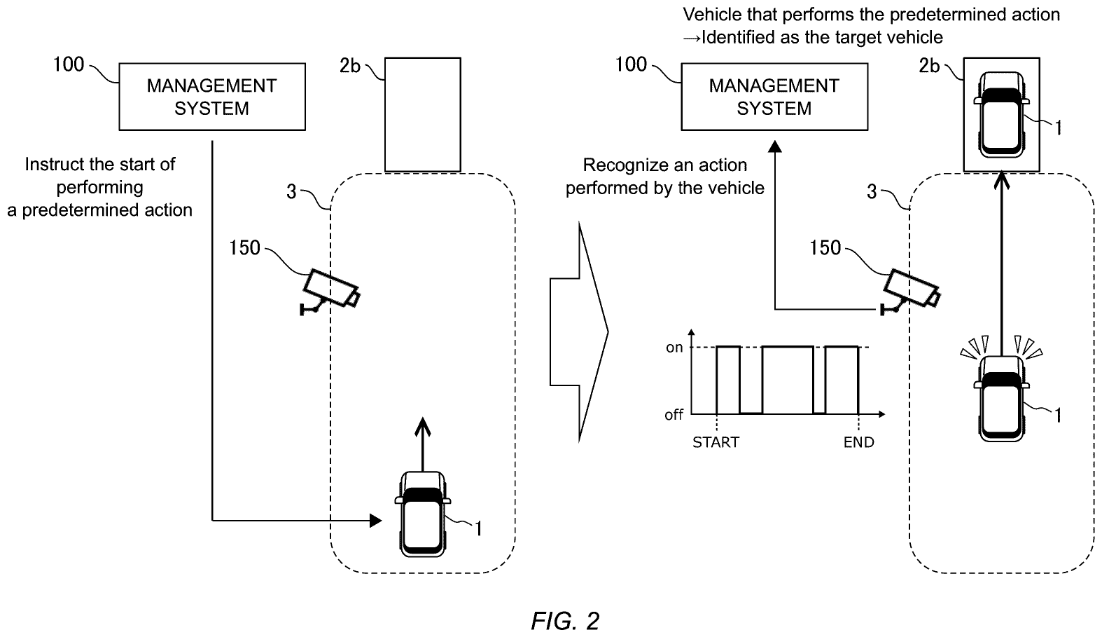

FIG. 2 is a conceptual diagram for explaining an outline of the vehicle identification system according to the present embodiment. The vehicle identification system according to the present embodiment can be configured by a management system 100 that executes processing and a sensor 150 that detects an action executed by the vehicle 1.

In the vehicle identification system according to the present embodiment, a vehicle identification zone 3 having a certain range is provided before the vehicle stop position 2b. The vehicle-stop-position 2b is a position at which the target vehicle is required to stop in the function of AVP or the like. It is assumed that the vehicle 1, which the user intends to receive the control service, passes through the vehicle identification zone 3, reaches the vehicle stop position 2b, and stops. The vehicle identification zone 3 may be provided as a virtual range in information processing.

In the vehicle identification system according to the present embodiment, when the vehicle 1 (first vehicle) travels in the vehicle identification zone 3, vehicle identification is started. First, the management system 100 instructs the vehicle 1 to start executing a predetermined action while the vehicle 1 is traveling in the vehicle identification zone 3. If vehicle 1 is a legitimate target vehicle, vehicle 1 is expected to start executing the predetermined action in accordance with the instruction. The vehicle 1 may be configured to execute a predetermined action in a plurality of cycles.

Next, the management system 100 starts a process (recognition process) of recognizing an action performed by the vehicle 1 (first vehicle) using the sensor 150 while the vehicle 1 is traveling in the vehicle identification zone 3. The management system 100 identifies the vehicle 1 that executes the predetermined action as the target vehicle. For example, when the predetermined action is flashing of a headlight, the management system 100 recognizes a flashing pattern from the detection information of the sensor 150 in the recognition process. Then, when the recognized pattern matches the operation pattern of the predetermined action, the management system 100 determines that the predetermined action has been executed, and identifies the vehicle 1 as the target vehicle. In particular, the vehicle identification system may be configured to complete the identification of the target vehicle before the vehicle 1 reaches the vehicle stop position 2b. For example, the management system 100 is configured to determine a predetermined action to be instructed by using a duration time of the action as an index according to a state (a speed, a position, or the like) of the vehicle 1.

After the identification of the target vehicles is completed, the management system 100 starts to provide control and service to the target vehicles stopped at the vehicle stop position 2b.

As described above, according to the present embodiment, at a time point before the vehicle 1 reaches the vehicle stop position 2b, the instruction to start the execution of the predetermined action is issued, and the recognition process is started. Thus, when the vehicle 1 reaches the vehicle stop position 2b, the identification of the target vehicle is completed, or a part of the action executed by the vehicle 1 is recognized. Therefore, the time during which the target vehicle stops at the vehicle stop position 2b can be shortened in the vehicle identification. In addition, it is possible to suppress the occurrence of a situation in which efficient traffic is hindered.

### 3. Camera Selection Process

In the following, a case is considered where the predetermined action to be instructed is a visible action and the sensor 150 used for the recognition process is configured by a camera in the vehicle identification system according to the present embodiment. In this case, the vehicle identification system needs to recognize the visible action executed by the vehicle 1 using the camera.

In the function of AVP or the like, the sensor 150 is assumed to include a plurality of cameras installed in a predetermined area (for example, parking lot 2). When the vehicle identification system according to the present embodiment is applied, a camera to be used for the recognition process is selected from among a plurality of cameras. Then, while the vehicle 1 is traveling in the vehicle identification zone 3, the recognition process using the selected camera is started.

Here, how to select a camera used for the recognition process will be considered. The camera has a range (hereinafter referred to as an “effective recognition range”) in which the camera can accurately detect a visible action, depending on the arrangement and specifications of the camera. The effective recognition range does not necessarily coincide with the angle of view of the camera. The effective recognition range may also depend on the relative distance to the vehicle 1 to be recognized, the relationship between the orientation of the camera and the orientation of the vehicle 1 to be recognized, and the like. In order to recognize the execution of the predetermined visible action by the vehicle 1, the vehicle 1 needs to be located in the effective recognition range of the camera used for the recognition process during a period from the start to the end of the predetermined visible action.

As one viewpoint, since the vehicle identification zone 3 is a range that can be determined in advance, it is conceivable to select one camera to be used for the recognition process in advance. For example, a camera having an effective recognition range of a certain range from the start position of the vehicle identification zone 3 may be used as the camera used in the recognition process. However, the vehicle 1 moves a certain distance during the time from the start to the end of the predetermined visible action. Therefore, there is a possibility that the entire range from the start to the end of a predetermined visible action cannot be captured within the effective recognition range of one camera. For example, the vehicle speed of the vehicle 1 is high, or the start of the predetermined visible action is delayed.

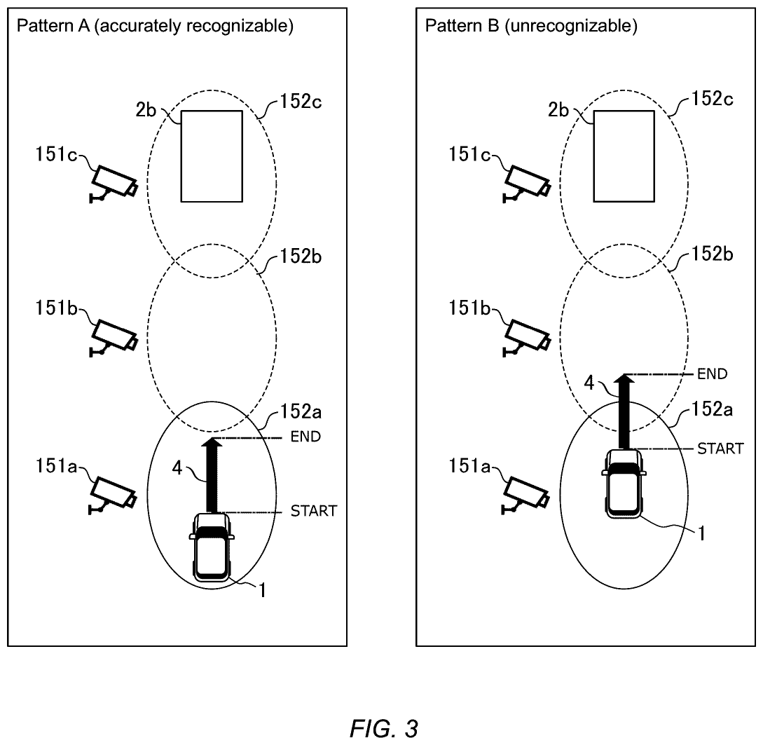

FIG. 3 is a conceptual diagram showing an example of the above problem. In FIG. 3, three cameras 151a, 151b, and 151c are shown as the sensors 150. Effective recognition ranges 152a, 152b, and 152c of the three cameras 151a, 151b, and 151c are also shown. The camera 151b is installed at a position where the camera 151a captures an image of the vehicle 1 later than the camera SL. Further, the camera 151c is installed at a position where the camera 151b captures an image of the vehicle 1 later than the camera SL.

FIG. 3 illustrates a case where the camera 151a is a camera used for the recognition process. In FIG. 3, two patterns, pattern A and pattern B, are shown for the situation of the recognition process. The pattern A shows a situation which is normally expected. In the pattern A, a section 4 from the start to the end of a predetermined visible action is included in the effective recognition range 152a of the camera 151a. Therefore, the execution of the predetermined visible action by the vehicle 1 can be normally recognized. On the other hand, the pattern B indicates a situation in which the start of the predetermined visible action is delayed. For example, a communication delay, a processing delay, or the like occurs. In the pattern B, a part of the section 4 is not included in the effective recognition range 152a. Therefore, the execution of the predetermined visible action by the vehicle 1 cannot be recognized, and the vehicle identification fails.

In this way, when the execution of the predetermined visible action cannot be normally recognized by the default camera, it is considered that the camera used for the recognition process is switched and the recognition process is restarted by the execution of the predetermined visible action in the next cycle. However, at this time, the recognition process performed by the default camera is a useless process. This is undesirable in terms of processing efficiency. If the camera is switched in response to the failure of the normal recognition, the start of the recognition process using the switched camera may be delayed. In addition, the failure of the vehicle identification may be repeated. It is also conceivable to sufficiently secure the effective recognition range by selecting a plurality of cameras used for the recognition process in advance. However, at this time, there is a possibility that there is a camera that has not been used in the recognition process. This is likewise undesirable in terms of processing efficiency.

Therefore, the vehicle identification system according to the present embodiment can be configured to execute a process (camera selection process) of selecting a camera to be used for the recognition process so that a predetermined visible action from the start to the end (hereinafter, referred to as “action interval”) can be recognized prior to the start of the recognition process.

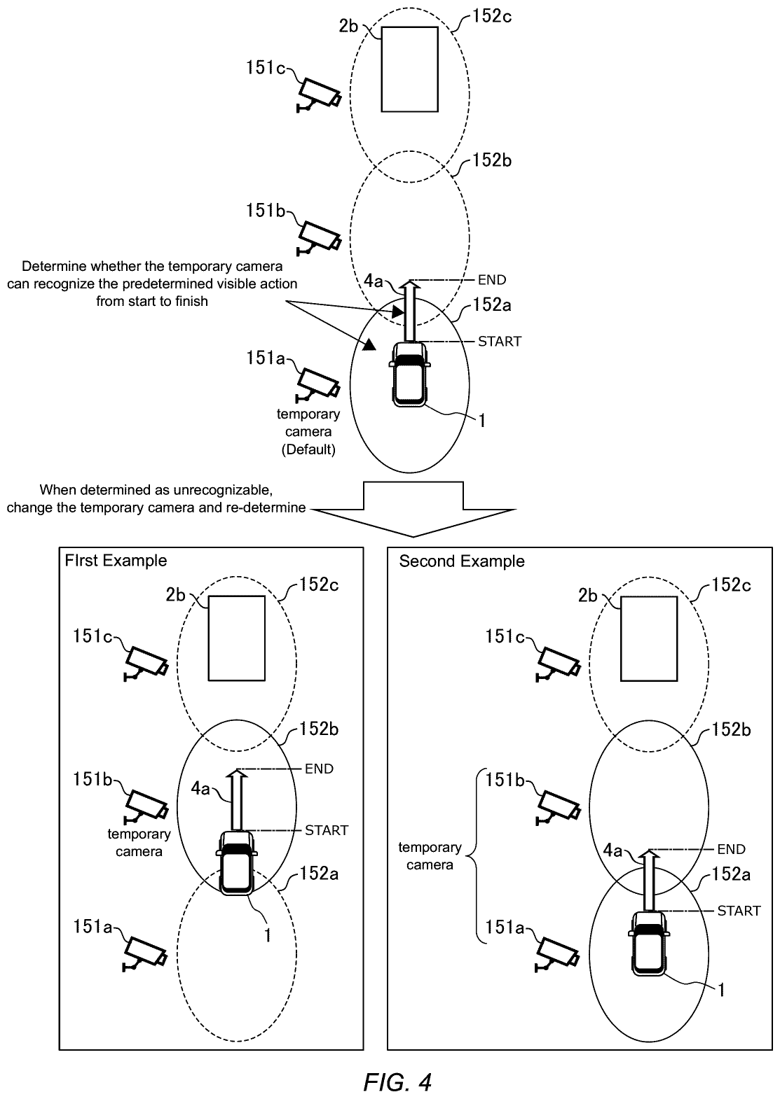

FIG. 4 is a conceptual diagram for explaining the outline of the camera selection process. In the camera selection process, first, a camera to be used in the recognition process is temporarily selected. In the tentatively selected stage, the recognition process is not started. The camera temporarily selected first may be a predetermined default camera. In FIG. 4, camera 151a is provisionally selected.

Next, in the camera selection process, a process (determination process) of determining whether or not the action interval can be recognized in the recognition process using the temporarily selected camera (temporary camera) is performed. The determination process may be performed by verifying whether the predicted interval 4a of the action interval is included in the effective recognition range of the temporary camera. The predicted interval 4a can be calculated based on the position at which the predetermined visible action is started (action start position), the duration of the predetermined visible action, and the speed of the vehicle 1. The action start position can be detected using a temporary camera. For example, the rising edge (first shot) of a predetermined visible action pattern is detected using a temporary camera, and the position of the vehicle 1 at that time is acquired as the action start position. The duration of the predetermined visible action is information known in the management system 100. The speed of the vehicle 1 can be recognized using a temporary camera. Alternatively, the information may be acquired through communication with the vehicle 1.

If the determination process determines that the action interval can be recognized by the temporary camera, the temporary camera is selected as the camera to be used in the recognition process. On the other hand, if the action interval cannot be recognized by the temporary camera, the temporary selection is performed again, and the temporary camera is changed. Then, the determination process is repeated again. This makes it possible to select a camera that has been confirmed in advance to be able to recognize the action interval as a camera to be used in the recognition process.

Here, as a method of changing the temporary camera, the following two examples are given. In the following example, the temporary camera that was temporarily selected last time is referred to as a “first camera”. One of the cameras installed at positions where the vehicle 1 is captured later than the first camera in the vehicle identification zone 3 is referred to as a “second camera”. For example, in FIG. 4, when camera 151a is the first camera, the second camera is camera 151b or camera 151c.

In the first example (see FIG. 4), the second camera is provisionally selected as the temporary camera. In FIG. 4, camera 151a is the first camera, and camera 151b is provisionally selected as the temporary camera. The effective recognition range of the second camera is expected to include all action intervals of the next and subsequent cycles. That is, when the second camera is selected as a camera to be used for the recognition process, it is assumed that the target of the recognition process is the action interval of the next and subsequent cycles. Therefore, in the determination process performed again in the first example, it is verified whether or not the predicted interval 4a in the next and subsequent cycles is included in the effective recognition range of the second camera. At this time, the action start position may be predicted from the action start position acquired last time, or may be detected using the second camera.

In the second example (see FIG. 4), a combination of the first camera and the second camera is temporarily selected as the temporary camera. In FIG. 4, camera 151a is the first camera, and a combination of camera 151a and camera 151b is temporarily selected as the temporary camera. The effective recognition range of the combination of the first camera and the second camera is an extension of the effective recognition range of the first camera, and thus is expected to include the predicted interval 4a. The second determination process in the second example may be performed in relation to the previously calculated predicted interval 4a and the effective recognition range of the combination of the first camera and the second camera.

By adopting the first example or the second example, a situation in which the determination process is excessively repeated is suppressed, and thus it is possible to effectively execute the camera selection process.

As described above, by executing the camera selection process, the vehicle identification system can start the recognition process using a camera that is confirmed in advance to be able to recognize the action interval. This can prevent failure of the vehicle identification process in the recognition process. As a result, the processing efficiency can be improved.

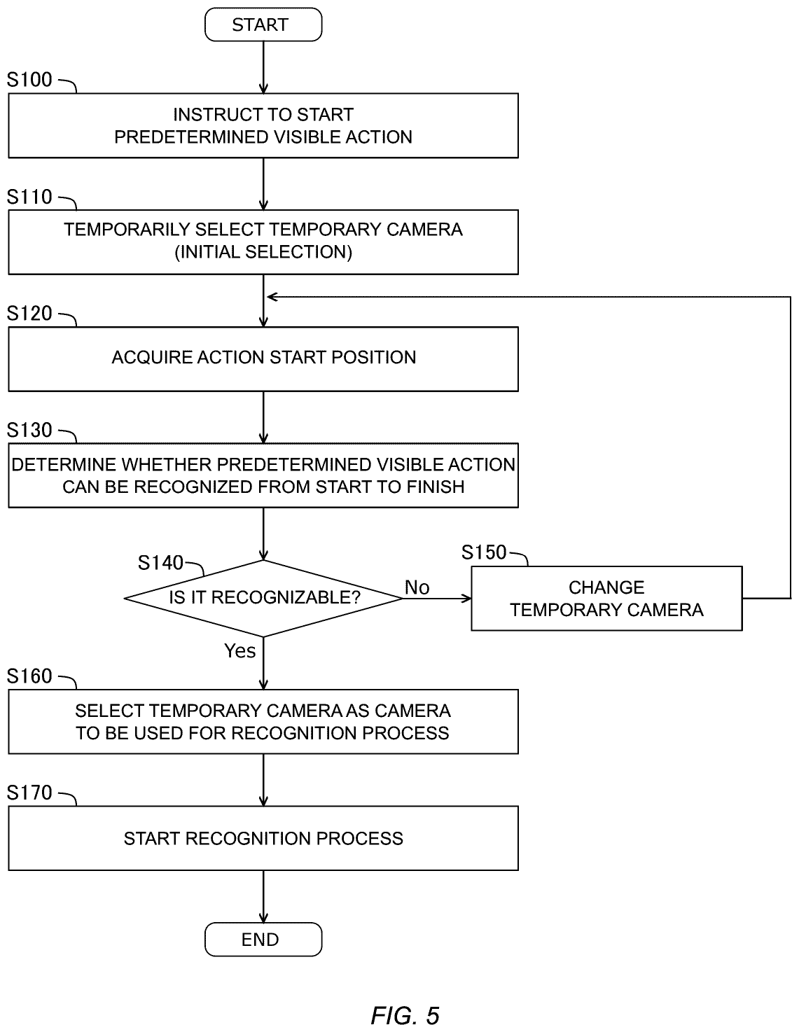

FIG. 5 is a flowchart showing an example of processing executed in the vehicle identification system in relation to the above-described camera selection process. The process according to the flowchart illustrated in FIG. 5 is started, for example, after the vehicle 1 enters the vehicle identification zone 3 and communication between the management system 100 and the vehicle 1 is established.

In step S100, the management system 100 instructs the vehicle 1 to start execution of a predetermined visible action.

Next, in step S110, the management system 100 provisionally selects a temporary camera. The tentative selection in step S110 is the first tentative selection (initial selection) in the camera selection process. For example, the management system 100 temporarily selects a predetermined default camera as the temporary camera.

After step S110, the management system 100 performs a determination process on the temporarily selected temporary camera. The management system 100 acquires the action start position using the temporary camera (step S120), and determines whether or not the temporary camera can recognize the start to end (action interval) of a predetermined visible action executed by the vehicle 1 (step S130).

When it is determined that the action interval cannot be recognized by the temporary camera by the determination process (step S140; No), the management system 100 changes the temporary camera (step S150) and performs the determination process again. Here, when the action start position acquired last time is referred to, the processing related to step S120 can be skipped.

When it is determined that the action interval can be recognized by the temporary camera by the determination process (step S140; Yes), the management system 100 selects the temporarily selected temporary camera as a camera to be used for the recognition process (step S160). The management system 100 starts the recognition process using the selected camera (step S170).

### 4. Hardware Configuration

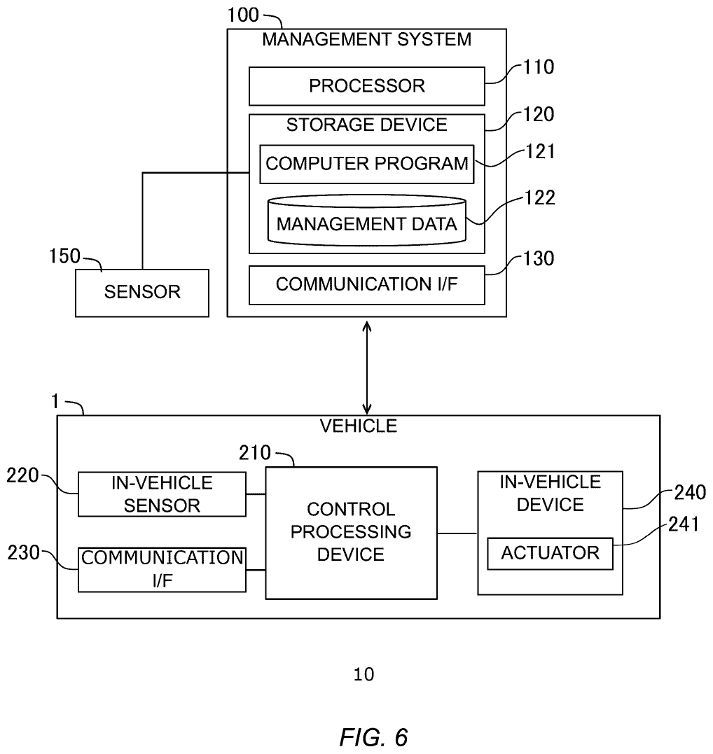

FIG. 6 is a diagram showing an example of a hardware configuration of the vehicle identification system 10 according to the present embodiment. The vehicle identification system 10 is configured between the vehicle 1 and the management system 100 that communicates with the vehicle 1. The vehicle identification system 10 includes a sensor 150 that is communicably connected to the management system 100.

The management system 100 includes a processor 110 (which may also be referred to as “processing circuitry”), a storage device 120, and a communication interface 130.

The processor 110 executes various processes. The processor 110 is configured by, for example, a central processing unit (CPU), a graphics processing unit (GPU), an application specific integrated circuit (ASIC), a field-programmable gate array (FPGA), or the like.

The storage device 120 is connected to the processor 110 and stores various kinds of information necessary for processing executed by the processor 110. The storage device 120 is configured by a recording medium such as a random access memory (RAM), a read only memory (ROM), a solid state drive (SSD), or a hard disk drive (HDD).

The storage device 120 stores a computer program 121 and management data 122.

The computer program 121 describes processing to be executed by the processor 110. The information processing by the management system 100 may be realized by cooperation between the processor 110 that executes the processing related to the computer program 121 and the storage device 120. In particular, information processing related to vehicle identification according to the present embodiment may be realized.

The management data 122 records various management information. For example, the management data 122 records management information (a device that executes an action, an operation pattern, and the like) regarding a predetermined action, management information (a position, a range, and the like) regarding the vehicle identification zone 3, management information (arrangement, specifications, a default camera, and the like) regarding the sensor 150, and the like.

The communication interface 130 is an interface for communicating with an external device of the management system 100 to transmit and receive information. For example, the communication interface 130 is configured by a device for connecting to a peripheral device via a wireless LAN, a device for connecting to a moving body communication network, a device for connecting to the Internet, and the like. The management system 100 transmits and receives information to and from the vehicle 1 via the communication interface 130.

The vehicle 1 includes a control processing device 210, an in-vehicle sensor 220, a communication interface 230, and an in-vehicle device 240.

The control processing device 210 is communicably connected to the in-vehicle sensor 220, the communication interface 230, and the in-vehicle device 240. The control processing device 210 is a computer that performs information processing related to control of the vehicle 1 based on various kinds of information. The control processing device 210 may include a processor and a memory. Then, the information processing by the control processing device 210 may be realized by cooperation of the processor and the memory device.

For example, the control processing device 210 is configured by one or a plurality of electronic control units (ECUs). For example, the control processing device 210 may be configured as a kit (e.g., an AVP kit) for a function provided by the management system 100. The control processing device 210 generates and outputs a control signal for controlling the vehicle 1 by information processing. In particular, when the vehicle 1 receives an instruction to start execution of a predetermined action from the management system 100, the control processing device 210 generates and outputs a control signal for executing the predetermined action. The control signal is transmitted to the in-vehicle device 240.

The in-vehicle sensor 220 detects information on the surrounding environment and the traveling state of the vehicle 1. Examples of the in-vehicle sensor 220 include a camera, a radar, a LiDAR, a wheel speed sensor, an inertial measurement unit (IMU), and a global navigation satellite system (GNSS) sensor.

The communication interface 230 is an interface for communicating with a device outside the vehicle 1 to transmit and receive information. The vehicle 1 transmits and receives information to and from the management system 100 via the communication interface 230.

The in-vehicle device 240 includes a lighting device, an in-vehicle illumination device, a horn, a direction indicator, a wiper, a door, a door window, a driving device, a braking device, a steering device, and the like. Each device of the in-vehicle device 240 includes an actuator 241 controllable by the control processing device 210. The in-vehicle device 240 acquires a control signal from the control processing device 210. The actuator 241 operates in accordance with the acquired control signal, and thus the control processing device 210 controls the in-vehicle device 240. The control of the vehicle 1 is realized by the control of the in-vehicle device 240.

What is claimed is:

1. A vehicle identification system for identifying a target vehicle, comprising processing circuitry configured to:
instruct a first vehicle to start performing a predetermined action for identifying the target vehicle while the first vehicle is traveling in a vehicle identification zone;
start a recognition process of recognizing an action performed by the first vehicle using a sensor while the first vehicle is travelling in the vehicle identification zone; and
identify the first vehicle that performs the predetermined action as the target vehicle.

2. The vehicle identification system according to claim 1, wherein
the predetermined action is a predetermined visible action,
the recognition process includes recognizing a visible action performed by the first vehicle using at least one camera, and
the processing circuitry is further configured to execute a camera selection process of selecting the at least one camera to be able to recognize the predetermined visible action from start to finish performed by the first vehicle.

3. The vehicle identification system according to claim 2, wherein
the camera selection process includes:
temporarily selecting a temporary camera;
executing a determination process of determining whether or not the temporary camera can recognize the predetermined visible action from start to finish performed by the first vehicle; and
when it is determined that the temporary camera can recognize the predetermined visible action from start to finish, selecting the temporary camera as the at least one camera.

4. The vehicle identification system according to claim 3, wherein
a second camera is installed at a position to capture the first vehicle after a first camera,
the camera selection process includes:
temporarily selecting the first camera as the temporary camera and executing the determination process; and
when it is determined that the temporary camera cannot recognize the predetermined visible action from start to finish, temporarily selecting the second camera as the temporary camera instead of the first camera and executing the determination process.

5. The vehicle identification system according to claim 3, wherein
a second camera is installed at a position to capture the first vehicle after a first camera,
the camera selection process includes:
temporarily selecting the first camera as the temporary camera and executing the determination process; and
when it is determined that the temporary camera cannot recognize the predetermined visible action from start to finish, temporarily selecting a combination of the first camera and the second camera as the temporary camera and executing the determination process.
